(19) United States
(12) Patent Application Publication
(10) Pub. No.: US 2026/0169465 A1
(43) Pub. Date: Jun. 18, 2026

(54) BODY BUILDER CONNECTION CONTROL DEVICE AND A METHOD THEREOF

(71) Applicants: HYUNDAI MOTOR COMPANY, Seoul (KR); KIA CORPORATION, Seoul (KR)

(72) Inventor: Dae Hyun Kim, Hwaseong-si (KR)

(73) Assignees: HYUNDAI MOTOR COMPANY, Seoul (KR); KIA CORPORATION, Seoul (KR)

(21) Appl. No.: 19/216,302

(22) Filed: May 22, 2025

(30) Foreign Application Priority Data
Dec. 13, 2024 (KR) 10-2024-0186422

(51) Int. Cl. G05B 19/418

(52) U.S. Cl. CPC G05B 19/41855; G05B 19/41815

(57) ABSTRACT

A body builder connection control device includes a memory storing computer-executable instructions and at least one processor configured to execute the computer-executable instructions. The at least one processor is configured to receive a connection request message from a body builder controller. The connection message includes a body builder information package including body builder verification information. The at least one processor is configured to perform verification of a body builder based on the body builder verification information included in the body builder information package. The at least one processor is configured to determine a connection between a vehicle and the body builder based on performing the verification of the body builder.

### CROSS-REFERENCE TO RELATED APPLICATION

This application claims the benefit of and priority to Korean Patent Application No. 10-2024-0186422, filed on Dec. 13, 2024, the entire contents of which are hereby incorporated herein by reference.

### TECHNICAL FIELD

The present disclosure relates to a body builder connection control device and a method thereof, and more particularly, to technologies for controlling a connection between a body builder and a vehicle.

### BACKGROUND

In the related art, if various body builders are mounted on a vehicle, settings of a vehicle controller may need be changed or updated to suit the different body builders mounted to the vehicle. However, it is generally impossible for the body builder to control the vehicle via communication with the vehicle. Due to this, there is a limitation in using a commercial vehicle to suit various purposes. In other words, because a conventional vehicle system operates with fixed settings to suit a specific body builder, there is a limitation in using the vehicle as a multipurpose vehicle.

### SUMMARY

The present disclosure has been made to solve the above-mentioned problems occurring in the prior art while advantages achieved by the prior art are maintained intact.

Embodiments of the present disclosure provide a method and a system capable of connecting and using various body builders without changing or updating settings of a body builder connection control device even when a body builder connected with the vehicle changes. Embodiments of the present disclosure may smoothly adjust settings in the vehicle to suit its purpose and implement the vehicle as a multipurpose vehicle in the form of a smart dynamic vehicle (SDV) via the connection with various body builders.

Aspects of the present disclosure provide a body builder connection control device and method. The body builder connection control device and method may perform verification of a body builder based on body builder verification information. The body builder verification information may be included in a body builder information package that, in turn, may be included in a connection request message received from a body builder controller. The body builder connection control device and method may determine a connection between a vehicle and the body builder to use the vehicle as a multi-purpose vehicle in the form of a smart dynamic vehicle (SDV), via connection with various body builders, based on performing the verification of the body builder.

The technical problems to be solved by the present disclosure are not limited to the aforementioned problems. Other technical problems not mentioned herein should be more clearly understood from the following description by those having ordinary skill in the art to which the present disclosure pertains.

According to an aspect of the present disclosure, a body builder connection control device is provided. The body builder connection control device includes a memory storing computer-executable instructions and at least one processor configured to execute the computer-executable instructions. The at least one processor is configured to receive a connection request message from a body builder controller. The connection request message includes a body builder information package including body builder verification information. The at least one processor is also configured to perform verification of a body builder based on the body builder verification information included in the body builder information package. The at least one processor is additionally configured to determine a connection between a vehicle and the body builder based on performing the verification of the body builder.

In an embodiment, the connection request message may further include a connection request controller area network (CAN) identifier. The body builder information package may further include at least one of body builder request information or body builder authentication information.

In an embodiment, the at least one processor may be configured to determine a connect mode of the body builder connection control device. The at least one processor may be also configured to identify requested connection information included in the body builder request information, based on determining that the connect mode of the body builder connection control device is a first connect mode capable of receiving a message requesting a connection from the body builder controller. The at least one processor may also be configured to transmit an error message to the body builder controller, based on determining that the connect mode of the body builder connection control device is a connect mode different from the first connect mode before a time point when the requested connection information is identified.

In an embodiment, the at least one processor may be configured to perform the verification of the body builder, based on determining that the requested connection information is a second connect mode capable of receiving a message indicating a state of the body builder from the body builder controller. The at least one processor may be configured to determine the second connect mode as the connect mode of the body builder connection control device, based on determining that the requested connection information is the second connect mode and the verification of the body builder is successful. The at least one processor may also be configured to transmit the error message to the body builder controller, based on determining that the requested connection information is the second connect mode and the verification of the body builder is not successful.

In an embodiment, the at least one processor may be configured to determine whether a manufacturer of the body builder is a manufacturer predetermined to be capable of controlling the vehicle, based on determining that the requested connection information is a third connect mode capable of receiving a message for vehicle control from the body builder controller. The at least one processor may be configured to perform verification of the body builder, based on determining that the manufacturer of the body builder is the manufacturer predetermined to be capable of controlling the vehicle.

In an embodiment, the at least one processor may be configured to transmit the error message to the body builder controller, based on determining that the requested connection information is the third connect mode and the manufacturer of the body builder is not the manufacturer predetermined to be capable of controlling the vehicle. The at least one processor may further be configured to determine whether the body builder is a body builder predetermined by a manufacturer of the vehicle, based on determining that the requested connection information is the third connect mode and the verification of the body builder is successful. The at least one processor may additionally be configured to determine the third connect mode as the connect mode of the body builder connection control device, based on determining that the body builder is the body builder predetermined by the manufacturer of the vehicle.

In an embodiment, the at least one processor may be configured to determine a type of the body builder, the type being included in the body builder verification information. The at least one processor may be configured to determine whether the type of the body builder is a body builder predetermined to be connectable with the vehicle to perform the verification of the body builder. The at least one processor may be configured to establish the connection between the vehicle and the body builder using information included in the body builder information package, based on determining that the type of the body builder is the body builder predetermined to be connectable with the vehicle. The at least one processor may also be configured to transmit a message indicating routing allowance to the body builder controller, based on establishing the connection between the vehicle and the body builder.

In an embodiment, the at least one processor may be configured to drop the connection request message, based on determining that the connection request message is received before a time point when activation of an ignition of the vehicle is identified. The at least one processor may be configured to transmit a connection or disconnection check request message to the body builder controller, based on identifying the activation of the ignition of the vehicle after a time point when the connection between the vehicle and the body builder is determined by the connection request message.

In an embodiment, the at least one processor may be configured to determine whether a first body builder information package and a second body builder information package are the same as each other, wherein the first body builder information package is included in the connection request message and the second body builder information package is included in the connection or disconnection check request message. The at least one processor may also be configured to maintain the connection between the vehicle and the body builder, based on determining that the first body builder information package and the second body builder information package are the same as each other. The at least one processor may further be configured to perform the verification of the body builder based on body builder verification information included in the second body builder information package, based on determining that the first body builder information package and the second body builder information package are different from each other.

In an embodiment, the at least one processor may be configured to determine the connection between the vehicle and the body builder, based on a result determined by performing the verification of the body builder based on the body builder verification information included in the second body builder information package.

According to another aspect of the present disclosure, a body builder connection control method is provided. The body builder connection control method includes receiving a connection request message from a body builder controller. The connection request message includes a body builder information package including body builder verification information. The body builder connection control method also includes performing verification of a body builder based on the body builder verification information included in the body builder information package. The body builder connection control method also includes determining a connection between a vehicle and the body builder based on performing the verification of the body builder.

In an embodiment, determining the connection between the vehicle and the body builder may include: determining a connect mode of a body builder connection control device; identifying requested connection information included in the body builder request information, based on determining that the connect mode of the body builder connection control device is a first connect mode capable of receiving a message requesting a connection from the body builder controller; and transmitting an error message to the body builder controller, based on determining that the connect mode of the body builder connection control device is a connect mode different from the first connect mode before a time point when the requested connection information is identified.

In an embodiment, determining the connection between the vehicle and the body builder may include: performing the verification of the body builder, based on determining that the requested connection information is a second connect mode capable of receiving a message indicating a state of the body builder from the body builder controller; determining the second connect mode as the connect mode of the body builder connection control device, based on determining that the requested connection information is the second connect mode and the verification of the body builder is successful; and transmitting the error message to the body builder controller, based on determining that the requested connection information is the second connect mode and the verification of the body builder is not successful.

In an embodiment, determining the connection between the vehicle and the body builder may include: determining whether a manufacturer of the body builder is a manufacturer predetermined to be capable of controlling the vehicle, based on determining that the requested connection information is a third connect mode capable of receiving a message for vehicle control from the body builder controller; and performing the verification of the body builder, based on determining that the manufacturer of the body builder is the manufacturer predetermined to be capable of controlling the vehicle.

In an embodiment, determining the connection between the vehicle and the body builder may include: transmitting the error message to the body builder controller, based on determining that the requested connection information is the third connect mode and the manufacturer of the body builder is not the manufacturer predetermined to be capable of controlling the vehicle; determining whether the body builder is a body builder predetermined by a manufacturer of the vehicle, based on determining that the requested connection information is the third connect mode and the verification of the body builder is successful; and determining the third connect mode as the connect mode of the body builder connection control device, based on determining that the body builder is a body builder predetermined by the manufacturer of the vehicle.

In an embodiment, determining the connection between the vehicle and the body builder may include: determining a type of the body builder, the type being included in the body builder verification information; determining whether the type of the body builder is a body builder predetermined to be connectable with the vehicle to perform the verification of the body builder; determining the connection between the vehicle and the body builder via information included in the body builder information package, based on determining that the type of the body builder is the predetermined body builder to be connectable with the vehicle; and transmitting a message indicating routing allowance to the body builder controller, based on determining that the connection between the vehicle and the body builder is established.

In an embodiment, determining the connection between the vehicle and the body builder may include: dropping the connection request message, based on determining that the connection request message is received before a time point when activation of an ignition of the vehicle is identified; and transmitting a connection or disconnection check request message to the body builder controller, based on identifying the activation of the ignition of the vehicle after a time point when the connection between the vehicle and the body builder is determined by the connection request message.

In an embodiment, determining the connection between the vehicle and the body builder may include: determining whether a first body builder information package and a second body builder information package are the same as each other, wherein the first body builder information package is included in the connection request message and the second body builder information package is included in the connection or disconnection check request message; maintaining the connection between the vehicle and the body builder, based on determining that the first body builder information package and the second body builder information package are the same as each other; and performing the verification of the body builder based on body builder verification information included in the second body builder information package, based on determining that the first body builder information package and the second body builder information package are different from each other.

In an embodiment, determining the connection between the vehicle and the body builder may include determining the connection between the vehicle and the body builder, based on a result determined by performing the verification of the body builder based on the body builder verification information included in the second body builder information package.

### BRIEF DESCRIPTION OF THE DRAWINGS

The above and other objects, features, and advantages of the present disclosure should be more apparent from the following detailed description taken in conjunction with the accompanying drawings, in which:

FIG. 1 is a drawing illustrating a block diagram of a body builder connection control device, according to an embodiment of the present disclosure;

FIG. 2 is a flowchart for describing a body builder connection control method, according to an embodiment of the present disclosure;

FIG. 3 is a drawing illustrating an example of a connection between a body builder connection control device and a body builder controller, according to an embodiment of the present disclosure;

FIG. 4 is a drawing illustrating at least one device included in a body builder connection control device, according to an embodiment of the present disclosure;

FIG. 5 is a flow diagram of operation according to a connection request message, in a body builder connection control device, according to an embodiment of the present disclosure;

FIG. 6 is a flowchart for describing a body builder verification control method according to a connection request message, in a body builder connection control device, according to an embodiment of the present disclosure;

FIG. 7 is a drawing illustrating an example of information included in a connection request message, according to an embodiment of the present disclosure;

FIG. 8 is a drawing illustrating an example of a controller of a vehicle accessible according to a type of a body builder, according to an embodiment of the present disclosure;

FIG. 9 is a flow diagram for describing a connection relationship between a body builder and a vehicle according to ignition activation of the vehicle, in a bodybuilder connection control device, according to an embodiment of the present disclosure;

FIG. 10 is a flowchart for describing a body builder verification method according to ignition activation of a vehicle, in a body builder connection control device, according to an embodiment of the present disclosure;

FIGS. 11A and 11B are drawings for describing an example of message transmission and reception according to a connect mode, in a body builder connection control device, according to an embodiment of the present disclosure;

FIGS. 12A and 12B are drawings illustrating an example of a controller of a vehicle accessible according to a type of a connected body builder, according to an embodiment of the present disclosure; and

FIG. 13 is a drawing illustrating a computing system associated with a body builder connection control device or a body builder connection control method, according to an embodiment of the present disclosure.

With regard to description of drawings, the same or similar components are designated by the same or similar reference signs.

### DETAILED DESCRIPTION

Hereinafter, embodiments of the present disclosure are described in detail with reference to the accompanying drawings. In adding the reference numerals to the components of each drawing, it should be noted that the identical components are designated by the identical numerals even when the components are displayed on different drawings. Further, in describing the embodiment of the present disclosure, where it was determined that a detailed description of well-known features or functions would unnecessarily obscure the gist of the present disclosure, the detailed description thereof has been omitted.

Various embodiments of the present disclosure are described with reference to the accompanying drawings. However, it should be understood that this is not intended to limit the present disclosure to specific implementation forms. Rather, the present disclosure includes various modifications, equivalents, and/or alternatives of embodiments of the present disclosure. With regard to description of drawings, similar components may be marked by similar reference numerals.

In describing components of embodiments of the present disclosure, the terms first, second, A, B, (a), (b), and the like may be used herein. These terms are only used to distinguish one component from another component. These terms do not limit the corresponding components irrespective of the order or priority of the corresponding components. Furthermore, unless otherwise defined, all terms including technical and scientific terms used herein have the same meaning as generally understood by those having ordinary skill in the art to which the present disclosure pertains. Such terms as those defined in a generally used dictionary should be interpreted as having meanings equal to the contextual meanings in the relevant field of art, and should not be interpreted as having ideal or excessively formal meanings unless clearly defined as having such in the present disclosure. Terms such as “first”, “second”, “1st”, “2nd”, or the like used in the present disclosure may be used to refer to various components regardless of the order and/or the priority and to distinguish one component from another component. Such terms do not limit the components. For example, “a first user device” and “a second user device” may indicate different user devices regardless of the order or priority thereof. Without departing the scope of the present disclosure, a first component may be referred to as a second component, and similarly, a second component may be referred to as a first component.

In the present disclosure, the expressions such as “have”, “may have”, “include” and “comprise”, or “may include” and “may comprise” indicate existence of corresponding features (e.g., components such as numeric values, functions, operations, or parts), but do not exclude presence of additional features.

It should be understood that when a component (e.g., a component) is referred to as being “(operatively or communicatively) coupled with/to” or “connected to” another component (e.g., a second component), the component can be directly coupled with/to, or connected with/to, the other component or one or more intervening components (e.g., a third component) may be present. In contrast, when a component (e.g., a first component) is referred to as being “directly coupled with/to” or “directly connected to” another component (e.g., a second component), it should be understood that there is no intervening component (e.g., a third component).

In the present disclosure, when a component, controller, device, element, apparatus, or the like of the present disclosure is described as having a purpose or performing an operation, function, or the like, the component, controller, device, element, apparatus, or the like should be considered herein as being “configured to” meet that purpose or to perform that operation or function. Each component, controller, device, element, module, apparatus, and the like may separately embody or be included with a processor and a memory, such as a non-transitory computer readable media, as part of the apparatus.

According to the situation, the expression “configured to” used in the present disclosure may be used interchangeably with, for example, the expression “suitable for”, “having the capacity to”, “designed to”, “adapted to”, “made to”, or “capable of”.

The term “configured to” does not necessarily mean “specifically designed to” in hardware. The expression “a device configured to” may mean that the device is “capable of” operating together with another device or other parts. For example, a “processor configured to perform A, B, and C” may mean a generic-purpose processor (e.g., a central processing unit (CPU) or an application processor) which may perform corresponding operations by executing one or more software programs on a dedicated processor (e.g., an embedded processor) for performing a corresponding operation or a memory device. Terms used in the present disclosure are used to describe specified embodiments and are not intended to limit the scope of the present disclosure. The terms of a singular form may include plural forms unless the context clearly indicates otherwise. All the terms used herein, including technical or scientific terms, may have the same meaning that is generally understood by a person having ordinary skill in the art to which the present disclosure pertains. It should be further understood that terms that are defined in a dictionary and commonly used should also be interpreted as is customary in the relevant related art and not in an idealized or overly formal manner unless expressly so defined herein in various embodiments of the present disclosure. In some cases, even though terms are defined in the specification, the terms may not necessarily be interpreted to exclude other embodiments of the present disclosure.

In the present disclosure, the expressions “A or B”, “at least one of A or/and B”, or “one or more of A or/and B”, and the like may include any and all combinations of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Furthermore, in describing an embodiment of the present disclosure, each of such phrases as “A or B”, “at least one of A and B”, “at least one of A or B”, “A, B, or C”, “at least one of A, B, and C”, “at least one of A, B, or C”, and “at least one of A, B, or C, or any combination thereof” may include any one of, or all possible combinations of the items enumerated together in a corresponding one of the phrases. For example, the phrase such as “at least one of A, B, or C, or any combination thereof” may include “A”, “B”, or “C”, or “AB” or “ABC”, which is a combination thereof.

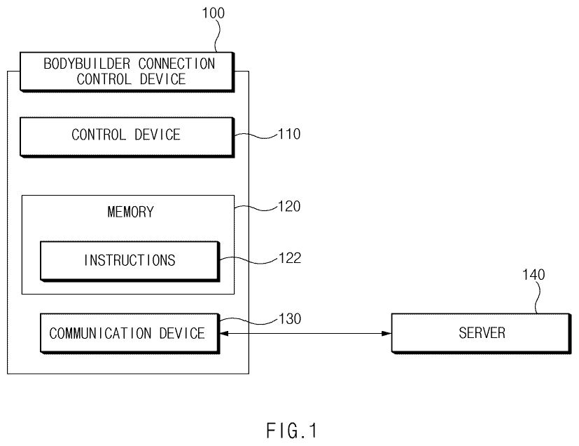

FIG. 1 is a drawing illustrating a block diagram of a body builder connection control device according to an embodiment of the present disclosure.

A body builder connection control device 100 according to an embodiment may include a processor 110, a memory 120 including instructions 122, and a communication device 130.

The body builder connection control device 100 may be a device designed to manage communication with various body builders mounted on a vehicle and smoothly connecting different body builders without a separate setting change or a system update. In an embodiment, the body builder connection control device 100 may control a connection with the body builder and may allow the connected body builder to communicate with the vehicle and suitably adjust a setting in the vehicle.

For example, the body builder connection control device 100 may support a connection with various body builders without a separate additional setting or update, regardless of a type of the body builder connected with the vehicle. In an embodiment, the body builder connection control device 100 may increase versatility of the vehicle, based on an item, such as a manufacturer, a type, or a weight of the body builder suitable for the vehicle.

For example, the body builder connection control device 100 may receive a body builder information package and may check suitability of the body builder. The body builder information package may include a connect mode, a manufacturer, a type, a weight, a working equipment ID, a certificate, and the like of the body builder. As a result, the body builder connection control device 100 may evaluate and/or verify a state and reliability of the body builder.

For example, the body builder connection control device 100 may perform communication with a controller included in the vehicle and may allow communication between the controller of the vehicle and the body builder, if an appropriate controller is connected. As a result, the vehicle may (e.g., automatically) configure a setting suitable for the purpose of the body builder and may perform a smooth setting depending to a characteristic of the connected body builder.

In an embodiment, the body builder connection control device 100 may support versatility for implementing a smart dynamic vehicle (SDV). The body builder connection control device 100 may adjust a setting depending to various purposes to optimize the vehicle. As a result, the body builder connection control device 100 may provide an opportunity for a commercial vehicle to be smoothly used in various industry fields.

For example, the body builder connection control device 100 may inspect and/or verify suitability of the body builder connection via a body builder certificate of the connected body builder and may allow only the reception of an authorized message to increase reliability of communication. As a result, the body builder connection control device 100 may prevent a system malfunction and may reinforce integrated control stability of the vehicle and the body builder.

The processor 110 may execute software (e.g., in the form of computer-readable instructions) and may control at least one other component (e.g., a hardware or software component) connected with the processor 110. In addition, the processor 110 may perform a variety of data processing or computation operations. For example, the processor 110 may store the connection request message and the body builder information package in the memory 120.

In an embodiment, the processor 110 may perform all operations performed by the body builder connection control device 100. Therefore, for convenience of description in the specification, the operation performed by the body builder connection control device 100 is mainly described as an operation performed by the processor 110. Furthermore, for convenience of description in the specification, the processor 110 is mainly described as, but not limited to, one processor. For example, the body builder connection control device 100 may include at least one processor. Each of the at least one processor may perform operations associated with the operation of controlling the connection between the vehicle and the body builder.

The memory 120 may temporarily and/or permanently store various pieces of data and/or information required to perform the operation of controlling the connection between the vehicle and the body builder. For example, the memory 120 may store the connection request message and the body builder information package.

The communication device 130 may enable communication between the body builder connection control device 100 and a server 140. For example, the communication device 130 may include one or more components for performing communication between the body builder connection control device 100 and the server 140. In an embodiment, the communication device 130 may include a short range wireless communication unit, a microphone, or the like. The short range wireless communication unit may implement a short range communication technology such as, but is not limited to, a wireless LAN (Wi-Fi), Bluetooth, ZigBee, Wi-Fi Direct (WFD), ultra-wideband (UWB), infrared data association (IrDA), Bluetooth low energy (BLE), near field communication (NFC), or the like.

In an embodiment, the server 140 may include a first server and a second server. For example, the first server may be an entity for performing control of the body builder, which may manage a request to generate a body builder certificate and may generate a control command associated with the body builder. In an embodiment, if a body builder company accesses a vehicle system (i.e., a target controller), the first server may check whether there is a certificate of the body builder company and may request the second server to generate the certificate, if the certificate is required. Due to this, the first server may effectively manage an access right of the body builder and may provide security by allowing only the authenticated body builder and/or the authenticated body builder company to securely access the vehicle system. The first server may provide a basis capable of providing various vehicle services, via the authentication of the body builder and the communication control.

The second server may manage control of the vehicle including the body builder connection control device 100 and may generate and manage the body builder certificate. In response to receiving the certificate generation request from the first server, the second server may generate the body builder certificate based on information of the body builder company and may transmit the generated body builder certificate to the first server. The second server may store information associated with a qualification of the body builder company. The second server may may thus issue and manage a certificate, and may provide a basis (i.e., the body builder certificate) capable of checking whether an external device for accessing the vehicle system is reliable. Furthermore, the second server may link a CAN identifier of each vehicle with the body builder certificate and may grant an access right to only a specific body builder, thus providing security of the vehicle system.

In general, the body builder may refer to an external company for installing or remodeling an additional device (e.g., a special or custom device) in the vehicle itself to allow the additional device to perform a specific function. For example, the body builder may include companies for adding a cargo space to a truck or performing work for remodeling a vehicle for special use, such as a fire truck, an ambulance, or a cleaning truck. The body builder may change or adapt a standard vehicle provided by a vehicle manufacturer to be suitable for special use to suit the needs of a user. The body builder may generally achieve the change or adaptation via the work of remodeling the appearance of the vehicle or an internal system of the vehicle.

The body builder may interact with a control system of a specific vehicle to control a vehicle function and/or may transmit a command to control the vehicle to perform a specific operation. For example, there may be a need for a fire truck to operate a water pump or control a fire-fighting related special device. Accordingly, there may be a need for the controller of the body builder to securely communicate with the vehicle. However, if such communication is abused by external hacking or unauthorized access, because it is capable of posing a serious danger to safety of the vehicle and a passenger, the body builder company should be a company authenticated by the manufacturer of the vehicle and should perform access in only an authenticated method for secure communication with the vehicle.

For convenience of description in the specification, the body builder may refer to an additional device installed in the vehicle itself as well as a company for installing or remodeling the additional device in the vehicle itself. In other words, the body builder may be the additional device installed in the vehicle itself and may further include a controller of the body builder, which may communicate with the vehicle.

The body builder certificate may be a digital certificate issued to a specific body builder company by a vehicle manufacturer or a certificate authority. The body builder certificate may comprise an electronic means for verifying that a controller of a corresponding body builder has a qualification capable of securely accessing the vehicle system. The body builder certificate may be generated in the process of verifying the legitimacy of the body builder company and may be used as an important element for reinforcing security in communicating with the vehicle system. The body builder certificate may include unique identification information of the body builder company, a certificate issue date, a validity period, and/or information about accessible vehicle control elements (e.g., a control item, a target controller, or the like). For example, controller area network (CAN) identifiers capable of being controlled by the controller of the specific body builder may be specified in the body builder certificate. As a result, the body builder certificate may ensure that the controller of the body builder accesses only a target controller or device of the vehicle. The body builder certificate may be used to block unnecessary access to a vehicle control system and ensure that an authorized task for only a specific function can be performed.

The body builder certificate may be issued and managed by the second server of the vehicle manufacturer and may be generated according to a certificate request of the first server. The body builder connection control device 100 may verify the body builder certificate and may determine routing, such that an instruction of the body builder is delivered to the target controller in the vehicle according to the information included in the body builder certificate. The body builder certificate may be a security measure for securely maintaining communication between the controller of the body builder and the target controller included in the vehicle. The body builder certificate may be used to allow the body builder company (i.e., the first server) approved by the vehicle manufacturer (e.g., the second server) to access the vehicle system in a secure manner and protect the vehicle and the driver from hacking or unauthorized access.

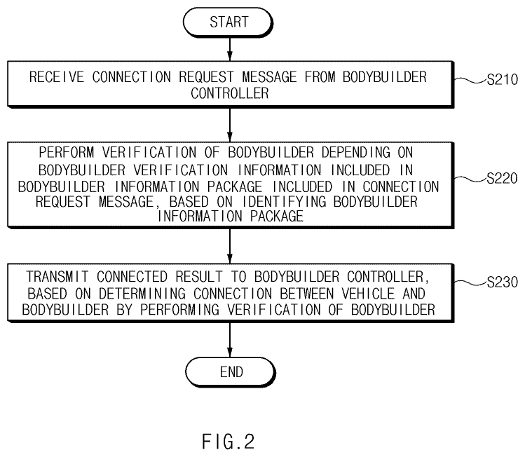

FIG. 2 is a flowchart for describing a body builder connection control method according to an embodiment of the present disclosure.

In an operation S210, a body builder connection control device (e.g., the body builder connection control device 100 of FIG. 1) according to an embodiment may receive a connection request message from a body builder controller. For example, the body builder connection control device may receive the connection request message from the body builder controller and may start a connection process. The connection request message may include information about a current state or a connection scheme of the body builder. As a result, a setting between the body builder and the vehicle may be determined. The received connection request message may include body builder identification information and data for a connection setting. The body builder connection control device may extract identification information from the connection request message, may check whether the body builder is an authorized device, and may perform the following operation for a necessary setting.

In an operation S220, the body builder connection control device may perform verification of the body builder based on body builder verification information included in a body builder information package included in the connection request message, based on identifying the body builder information package.

The body builder connection control device may determine reliability of the body builder, based on the body builder verification information included in the body builder information package, for example, a certificate, manufacturer information, a type, and/or other identification information of the body builder. The body builder connection control device may check whether the connected body builder satisfies a requirement of the vehicle or is a body builder included in an approved list of the system, based on the body builder verification information.

In an operation S230, the body builder connection control device may determine a connection between the vehicle and the body builder by performing the verification of the body builder.

For example, if the body builder successfully passes the verification procedure, the body builder connection control device may permit the connection of the body builder and may activate communication between the body builder and the vehicle. The body builder connection control device may allow a vehicle control system to adjust a vehicle setting based on information of the body builder and may control a connection such that it is possible to perform a setting suitable for a purpose. The verified body builder may ensure secure communication with a vehicle system.

On the other hand, the body builder connection control device may limit the body builder that fails verification. For example, the body builder connection control device may not allow the body builder that fails verification to be connected with the vehicle system. In an embodiment, if the certificate and/or the other verification information of the body builder is inappropriate, the body builder connection control device may block a communication request of the body builder or may return an error message to refuse a connection. The body builder connection control device may prevent a malfunction or a safety program of the vehicle system due to the inappropriate body builder, via the above-mentioned operation.

In an embodiment, the body builder connection control device may determine a type of the body builder based on a type indication included in the body builder verification information. The body builder connection control device may determine whether the type of the body builder (i.e., the type of the body builder requested for connection) is a body builder predetermined to be connectable with the vehicle to perform verification of the body builder.

The body builder connection control device may establish a connection between the vehicle and the body builder using the information included in the body builder information package, based on determining that the type of the body builder is the body builder predetermined to be connectable with the vehicle. The body builder connection control device may transmit a message indicating routing allowance to the body builder controller, based on determining that the connection between the vehicle and the body builder is determined to be allowed.

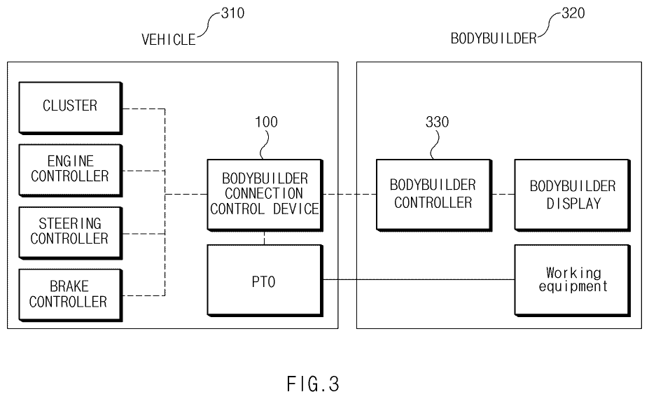

FIG. 3 is a drawing illustrating an example of a connection between a body builder connection control device and a body builder controller according to an embodiment of the present disclosure.

Referring to FIG. 3, FIG. 3 is a drawing illustrating a configuration of a body builder connection system including the body builder connection control device 100 according to an embodiment of the present disclosure. The body builder connection control device 100 may be a device that takes charge of communication and control between a vehicle 310 and a body builder 320 thus allowing the vehicle 310 and the body builder 320 to interconnect and cooperate with each other to implement various functions of the vehicle 310.

The vehicle 310 may include a cluster, an engine controller, a steering controller, and/or a brake controller. The controllers shown in FIG. 3 may be devices for controlling a main function of the vehicle 310. The controllers may be connected with the body builder connection control device 100 to control the function based on information and/or a message received from the body builder 320. Furthermore, because a power take-off (PTO) device is included in the vehicle 310 besides the body builder connection control device 100, the PTO may supply additional power required by the body builder 320.

The body builder 320 may be a special or custom device attached to the vehicle 310. The body builder 320 may include a body builder controller 330, a body builder display, and working equipment. The body builder controller 330 may be connected with the body builder connection control device 100 to perform communication between the vehicle 310 and the body builder 320 and deliver a state and control information of the body builder 320 to the vehicle 310. The body builder display may visually display a state, information, or the like of the body builder 320 during operation of the body builder 320. The working equipment may be a device that may execute work to be performed by the body builder 320 as the body builder 320 is mounted on the vehicle 310. For example, the working equipment may include a ladder truck, a dump truck, a crane, a cleaning truck, a fire pump truck, or a garbage truck.

The body builder connection control device 100 may be located in the vehicle 310 and may play a role in identifying information of the body builder 320 based on a connection request message received from the body builder controller 330 and activating communication between the body builder 320 and the vehicle 310. The body builder connection control device 100 may perform a body builder verification procedure to connect only the appropriate body builder 320 with the vehicle 310 and may supply power to the body builder 320 if necessary via the PTO device.

Thus, the system configuration including the body builder connection control device 100 shown in FIG. 3 may support an integrated control and stable operation between the vehicle 310 and the body builder 320 and may provide availability as a multi-purpose commercial vehicle.

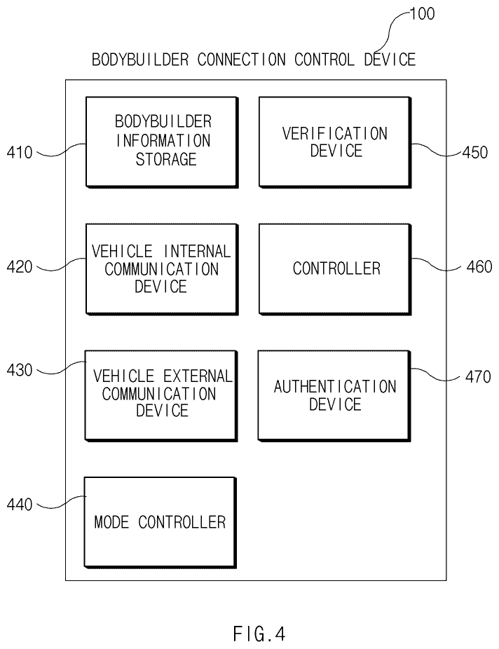

FIG. 4 is a drawing illustrating components included in a body builder connection control device according to an embodiment of the present disclosure.

FIG. 4 is a drawing illustrating components of a body builder connection control device 100 according to an embodiment of the present disclosure. The body builder connection control device 100 include several components for managing communication and control between a vehicle (e.g., the vehicle 310 of FIG. 3) and a body builder (e.g., the body builder 320 of FIG. 3). The respective components may play the following roles.

Body builder information storage 410 may be a memory device for storing various pieces of information about a body builder. The body builder information storage 410 may store and manage a body builder information package including basic information, such as a manufacturer, a type, a weight, and a connect mode of the body builder. The information may be used as data necessary for verification and setting upon communication between the vehicle and the body builder and may play an important role in determining suitability of the body builder. For example, the body builder information storage 410 may store a type of the body builder connectable with the vehicle. The body builder connection control device 100 may determine whether it is possible to connect the body builder which transmits a connection request message, based on the type of the body builder, stored in the body builder information storage 410.

A vehicle internal communication device 420 may perform communication between the body builder connection control device 100 and other control devices (e.g., an engine controller, a brake controller, and/or the like) in the vehicle. The vehicle internal communication device 420 may perform a necessary setting based on a request received from the body builder via data exchange with each component in the vehicle and may deliver various pieces of information of a vehicle control system to the body builder connection control device 100.

A vehicle external communication device 430 may be a device that takes charge of external communication with a body builder controller. The vehicle external communication device 430 may relay data transmission and reception between the inside of the vehicle and the body builder controller. The vehicle external communication device 430 may receive a connection request message transmitted from the body builder and may allow communication with the body builder controller when suitability of the body builder is verified.

A mode controller 440 may control a connect mode and an operation mode of the body builder connection control device 100. The mode controller 440 may set a connect mode of the body builder connection control device 100 based on a purpose of use of the body builder and may operate a power take-off (PTO) device if necessary to supply power required by the body builder.

A verification device 450 may determine suitability of the body builder based on verification information included in the body builder information package. The verification device 450 may analyze a certificate, an ID, and/or other verification data of the body builder to check whether the body builder is a body builder suitable for the vehicle and may allow a connection with the vehicle, only if the verification is successful. The body builder that fails the verification may maintain safety of vehicle operation by not being connected with a vehicle system.

A controller 460 may be a central control unit (or a processor) for controlling the entire operation of the body builder connection control device 100. The controller 460 may sum data between respective components to manage a connection between the vehicle and the body builder. The controller 460 may adjust a vehicle setting based on a state and a request of the body builder and may process an error, if detecting the error, to provide secure communication between the vehicle and the body builder.

An authentication device 470 may perform an authentication procedure of the body builder connected with the vehicle. The authentication device 470 may review the certificate received from the body builder and may allow only an approved body builder to be connected with the vehicle system. The authentication device 470 may play an important role in ensuring reliability of the body builder and may block communication to prevent unnecessary risk, if it fails in authentication.

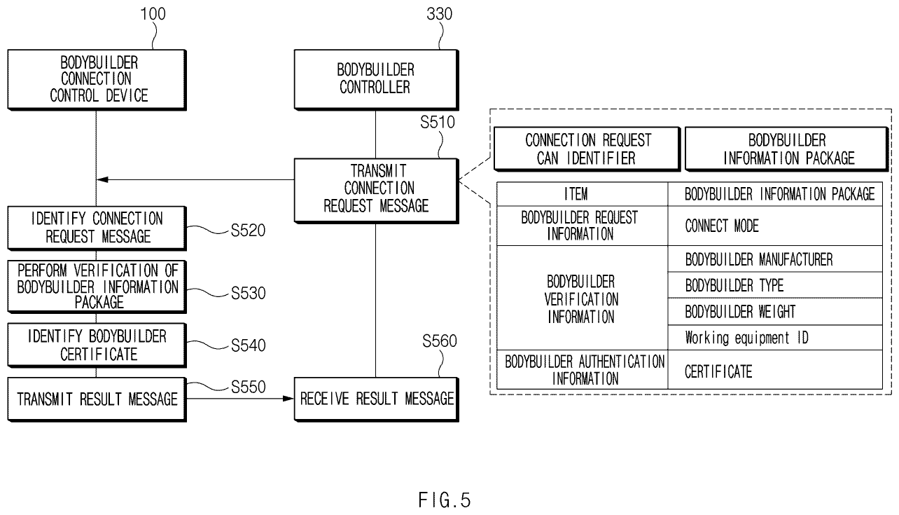

FIG. 5 is a flow diagram of operation according to a connection request message, in a body builder connection control device according to an embodiment of the present disclosure.

Referring to FIG. 5, FIG. 5 illustrates a flow diagram of operation according to a connection request message between a body builder connection control device 100 and a body builder controller 330 according to an embodiment.

In an operation S510, the body builder controller 330 may transmit a connection request message. In an embodiment, the connection request message may include a connection request controller area network (CAN) identifier and a body builder information package. The body builder information package may include at least one of body builder request information, body builder authentication information, or body builder verification information, or any combination thereof.

For example, a CAN identifier may refer to a unique identifier of a data frame transmitted over a CAN in the vehicle. Various electronic control units (ECUs) in the vehicle may communicate over the CAN and may specify a specific control device or function on the network, because each data frame has a unique ID. In an embodiment, the CAN identifier may include an identifier, such as 0x748, 0x562, or 0x981, and may be used as a unique ID referring to a specific function or a control command.

In an operation S520, the body builder connection control device 100 may identify the connection request message. The body builder connection control device 100 may receive the connection request message transmitted from the body builder controller 330 and may check the CAN identifier to extract a body builder information package.

In an operation S530, the body builder connection control device 100 may perform verification of the body builder information package. For example, the body builder connection control device 100 may determine a type of the body builder, based on a type indication included in the body builder verification information. The body builder connection control device 100 may determine whether the type of the body builder (i.e., the type of the body builder requested for connection) is a body builder predetermined to be connectable with the vehicle to perform verification of the body builder.

In an operation S540, the body builder connection control device 100 may identify a body builder certificate. In an operation S550, the body builder connection control device 100 may transmit a result message. For example, the result message may include an error message or a message indicating routing allowance.

In an embodiment, routing may indicate a process of determining a destination controller (e.g., a target controller) for a body builder connection control device (e.g., that may act as a gateway) to transmit specific data on the CAN and setting a data frame to move along a correct path. The body builder connection control device may determine to which controller the instruction is transmitted, based on the CAN identifier identified via the body builder certificate.

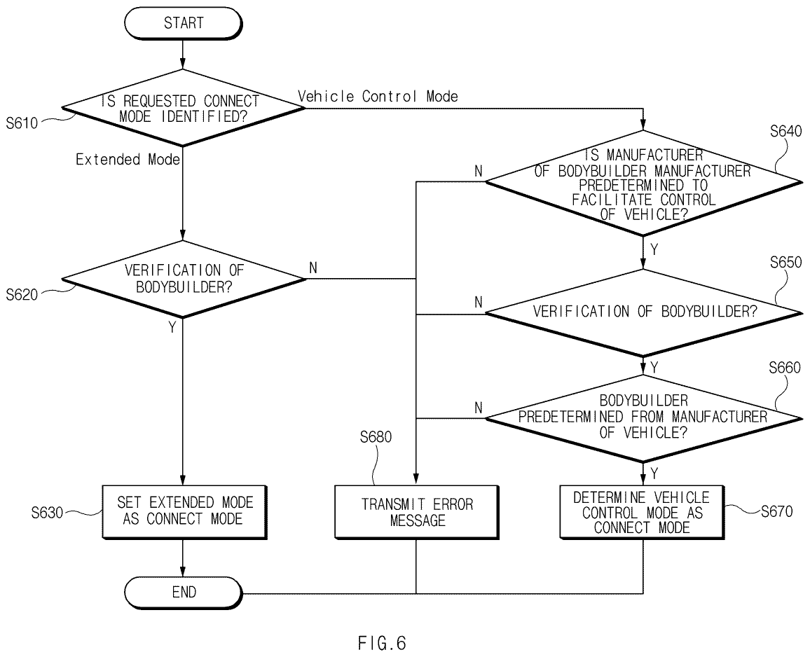

FIG. 6 is a flowchart for describing a body builder verification method according to a connection request message, in a body builder connection control device according to an embodiment of the present disclosure.

In an operation S610, a body builder connection control device (e.g., the body builder connection control device 100 of FIG. 1) according to an embodiment may determine a requested connect mode. For example, the body builder connection control device may determine a connect mode of the body builder connection control device. If the connect mode of the body builder connection control device is a first connect mode capable of receiving a message requesting a connection from a body builder controller, the body builder connection control device may identify requested connection information included in body builder request information. In an embodiment, if the connect mode of the body builder connection control device is a connect mode different from the first connect mode before the time point when the requested connection information is identified, the body builder connection control device may transmit an error message to the body builder controller.

In an embodiment, the connect mode of the body builder connection control device may include the first connect mode, a second connect mode, and a third connect mode.

For example, the first connect mode (e.g., a default mode) may be an initial connection state. The first connect mode may be a mode in which only default communication between the vehicle and the body builder is allowed. It is possible to receive only the connection request message from the body builder controller in the first connect mode. It is impossible to transmit data from the body builder connection control device and the body builder controller in the first connect mode. The first connect mode may allow only default reception such that the vehicle is able to identify a connection request of the body builder and may be used as an initial state before the connection is approved. Illustratively, the first connect mode may include a connect mode ID: 0x00, TX impossibility, and a condition in which it is possible to receive a connection request message from an RX body builder controller.

For example, the second connect mode (e.g., an extended mode) may be a mode for supporting extended communication between the vehicle and the body builder. The second connect mode may be a mode in which it is possible to transmit and receive an additional message, other than default communication. The second connect mode may be a mode capable of receiving a state message from the body builder controller and transmitting a specific message to the body builder controller if necessary. The body builder connection control device may receive current state information of the body builder via the state message and may reflect the current state information in a vehicle setting. Illustratively, the second connect mode may include a connect mode ID: 0x01, message transmission necessary for a TX body builder controller, and a condition in which it is possible to receive a state message transmitted from the RX body builder controller.

For example, the third connect mode (e.g., a vehicle control mode) may be a mode in which the vehicle is able to receive a direct control command via communication with the body builder. The third connect mode may be a mode capable of receiving a vehicle control message from body builder equipment and transmitting a specific message to the body builder controller if necessary. The body builder connection control device may allow the body builder to control a specific function (e.g., PTO control, an engine operation state, or the like) of the vehicle via the vehicle control message. Illustratively, the third connect mode may include a connect mode ID: 0x02, message transmission necessary for the TX body builder controller, and a condition in which it is possible to receive a vehicle control message transmitted from the RX body builder equipment.

If the requested connection information is the second connect mode capable of receiving the message indicating the state of the body builder from the body builder controller, in an operation S620, the body builder connection control device may perform verification of the body builder.

In an operation S630, the body builder connection control device may determine and/or set the second connect mode as the connect mode of the body builder connection control device, based on determining that the requested connection information is the second connect mode and the verification of the body builder is successful.

In an operation S680, the body builder connection control device may transmit an error message to the body builder controller, based on determining that the requested connection information is the second connect mode and the verification of the body builder is not successful.

If the requested connection information is the third connect mode capable of receiving the message for the vehicle control from the body builder controller, in an operation S640, the body builder connection control device may determine whether a manufacturer of the body builder is a manufacturer predetermined to be capable of controlling the vehicle.

If the manufacturer of the body builder is a manufacturer predetermined to be capable of controlling the vehicle, in an operation S650, the body builder connection control device may perform verification of the body builder.

If the requested connection information is the third connect mode and the manufacturer of the body builder is not a manufacturer predetermined to be capable of controlling the vehicle, in an operation S680, the body builder connection control device may transmit an error message to the body builder controller.

In an operation S660, the body builder connection control device may determine whether the body builder is a body builder predetermined by the manufacturer of the vehicle, based on determining that the requested connection information is the third connect mode and the verification of the body builder is successful.

If the body builder is the body builder predetermined by the manufacturer of the vehicle, in an operation S670, the body builder connection control device may determine the third connect mode as the connect mode of the body builder connection control device.

If the connect mode is changed, the body builder connection control device may allow routing.

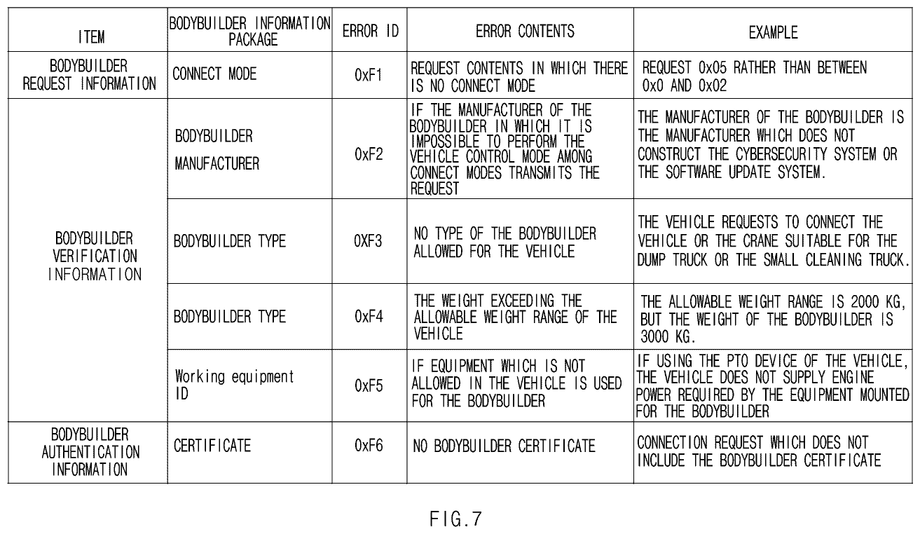

FIG. 7 is a drawing illustrating an example of information included in a connection request message of the present disclosure.

Referring to FIG. 7, FIG. 7 illustrates an example of information included in a connection request message. For example, a body builder connection control device (e.g., the body builder connection control device 100 of FIG. 1) may receive a connection request message from a body builder controller (e.g., the body builder controller 330 of FIG. 3) and may review a body builder information package included in the message to determine connection suitability of a body builder.

Various items of body builder information may be included in the connection request message. Each item may include information capable of detecting an error together with a specific ID.

The connection request message may include body builder request information and may include an item indicating whether the body builder wants to be connected with a vehicle in any form. The body builder request information may include a connect mode. For example, the connect mode may indicate a connect mode of the body builder and may be identified as a “0xF1” ID. If a correct value is not properly specified in the connect mode, an error may occur. For example, if an unauthorized 0x05 value is requested, the error “request contents in which there is no connect mode” may occur.

Body builder verification information may include a body builder manufacturer, a body builder type, a body builder weight, and a working equipment ID.

The body builder manufacturer may be information indicating a manufacturer of the body builder, which may be identified as a “0xF2” ID. To request a specific connect mode (e.g., a vehicle control mode), the body builder manufacturer should be suitable for a vehicle system. If a manufacturer in which a cybersecurity system or a software update system is not constructed requests the specific connect mode, the error “the manufacturer in which it is impossible to perform the vehicle control mode” may occur.

The body builder type may indicate a type of the body builder, which may be identified as a “0xF3” ID. If the body builder type is not a body builder type suitable for the vehicle, the error “no type of the body builder allowed for the vehicle” may occur. For example, if a crane connection request unsuitable for a dump truck or a small cleaning truck is received, an error may occur.

The body builder weight may be information indicating a weight of the body builder, which may be identified as a “0xF4” ID. If a body builder exceeding an allowable weight range of the vehicle is connected, the error “the weight exceeding the allowable weight range” may occur. For example, if the allowable weight range of the vehicle is 2000 kg, but the weight of the body builder is 3000 kg, an error may occur.

The working equipment ID may be an ID of working equipment mounted on the body builder, which may be identified as a “0xF5” ID. If equipment that is not allowed in the vehicle is used, the error “the use of equipment which is not allowed” may occur. For example, an error may occur in a situation in which mounted equipment does not supply engine power of the vehicle, if the body builder uses a power take-off (PTO) device.

Body builder authentication information may be information for ensuring reliability of the body builder, which may indicate an important element for determining whether the body builder to be connected with the vehicle is authenticated. In an embodiment, a certificate may be information indicating whether a certificate of the body builder is included, which may be identified as a “0xF6” ID. If the body builder does not include an appropriate certificate, the error “no body builder certificate” may occur. For example, if the body builder certificate is not included to request a connection, a vehicle connection may be refused.

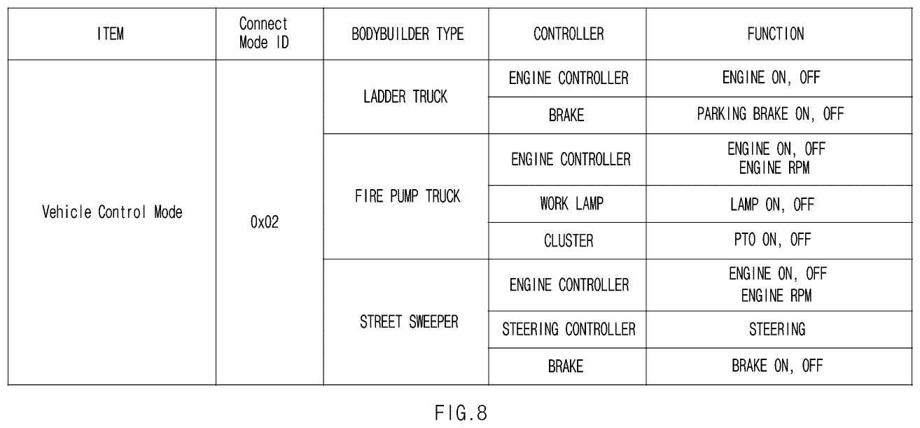

FIG. 8 is a drawing illustrating an example of a controller of a vehicle accessible according to a type of a body builder of the present disclosure.

Referring to FIG. 8, FIG. 8 illustrates information enabling accessing a specific controller of a vehicle based on a type of a body builder in a third connect mode (i.e., a vehicle control mode) (0x02) of a body builder connection control device of the present disclosure.

The third connect mode may be a mode for allowing the body builder to access a control system of the vehicle and control a necessary function, which may be set to be different in function from an accessible controller based on the type of the body builder.

For example, a body builder for a ladder truck may be able to access an engine controller and a brake controller. As a control function, the body builder may control On/Off of the engine via the engine controller and may control On/Off of the parking brake via the brake controller. Because it is important to stably stop the ladder truck when the ladder truck is performing work, there is a need to control the brake and the engine. As a result, the ladder truck may perform work in a state in which it is safely parked.

As another example, a body builder for a fire pump truck may be accessible to the engine controller, a work lamp controller, and a cluster. As a control function, the body builder may control On/Off of the engine and engine RPM via the engine controller, may control On/Off of the pump via the work lamp controller, and may control On/Off of the power take-off (PTO) device via the cluster. Because the fire pump truck should adjust engine RPM to control pressure of the pump, it is important to control the engine RPM. Furthermore, the body builder may control the PTO device via the cluster to supply necessary additional power during work. The fire pump truck may effectively perform fire control work via such a function.

As yet another example, a body builder for a street sweeper may be able to access the engine controller, the steering controller, and the brake controller. As a control function, the body builder may control On/Off of the engine and engine RPM via the engine controller, may control a steering function via the steering controller, and may control On/Off of the brake via the brake controller. Because the street sweeper moves a narrow space during cleaning work or requires detailed manipulation, steering control access may be allowed for the street sweeper. Furthermore, the body builder may adjust RPM of the engine during work to perform work using an appropriate output. Brake control supports to safely stop if necessary.

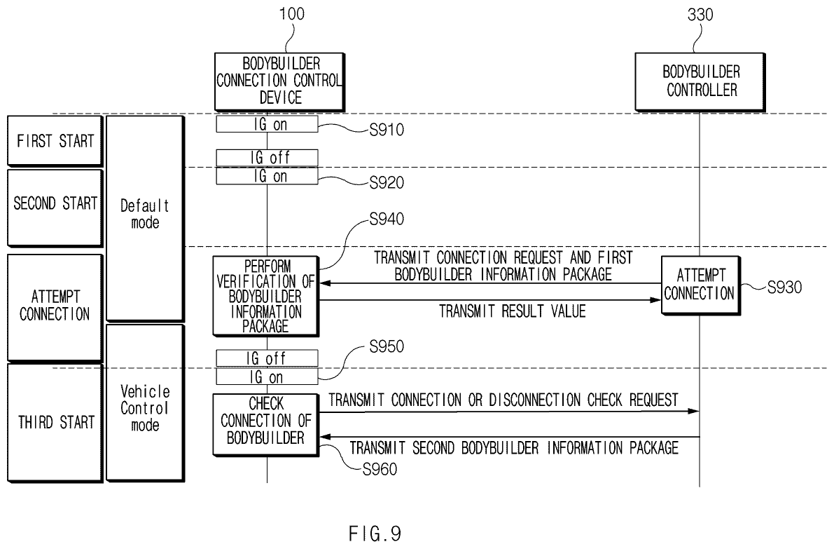

FIG. 9 is a flow diagram for describing a connection relationship between a body builder and a vehicle according to ignition activation of the vehicle, in a body builder connection control device according to an embodiment of the present disclosure.

Referring to FIG. 9, in an operation S910, a body builder connection control device (e.g., the body builder connection control device 100 of FIG. 1) may identify activation of the ignition. In an operation S920, the body builder connection control device may identify the activation of the ignition.

In an operation S930, a body builder controller (e.g., the body builder controller 330 of FIG. 3) may attempt a connection. In an embodiment, the body builder controller may transmit a connection request message for a connection with a vehicle. The connection request message may include a first body builder information package.

In an operation S940, the body builder connection control device may perform verification of the body builder information package. For example, if the connection request message is received before a time point (i.e., operation S910 or S920) when the activation of the ignition of the vehicle is identified, the body builder connection control device may drop the connection request message. The body builder connection control device may transmit a result message, based on determining that the verification of the body builder is successful.

In an operation S950, the body builder connection control device may identify the activation of the ignition. For reference, it is described that the activation of the ignition, which is identified in the operation S950, is identified after the vehicle and the body builder are connected with each other.

In an operation S960, the body builder connection control device may check a connection of the body builder. In an embodiment, the body builder connection control device may transmit a connection or disconnection check request message to the body builder controller, based on identifying the activation of the ignition of the vehicle after a time point when the connection between the vehicle and the body builder is determined by the connection request message (i.e., before operation S950). The body builder controller may transmit a second body builder information package, based on receiving the connection or disconnection check request message from the body builder connection control device 100.

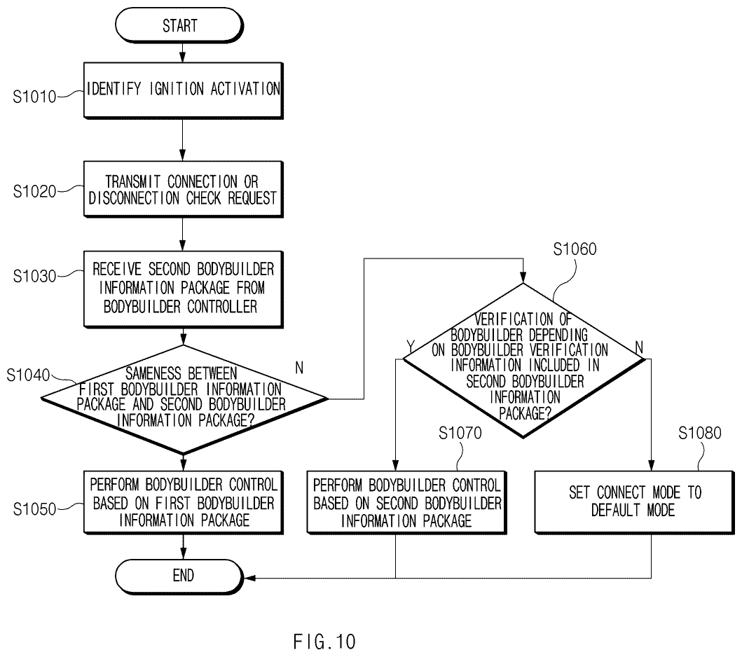

FIG. 10 is a flowchart for describing a body builder verification method according to ignition activation of a vehicle, in a body builder connection control device according to an embodiment of the present disclosure.

In an operation S1010, a body builder connection control device (e.g., a body builder connection control device 100 of FIG. 1) according to an embodiment may identify ignition activation of a vehicle. For reference, the ignition activation of the vehicle described in S1010 may be the same as the ignition activation in the operation S950 described above in FIG. 9.

In S1020, the body builder connection control device may transmit a connection or disconnection check request message. For reference, the transmission of the connection or disconnection check request message described in S1020 may be the same as S960 described above in FIG. 9.

In S1030, the body builder connection control device may receive a second body builder information package from a body builder controller. For reference, the reception of the second body builder information package described in S1030 may be the same as the reception of the second body builder information package after S960 described above in FIG. 9.

In S1040, the body builder connection control device may determine whether there is sameness between the first body builder information package and the second body builder information package. For example, the body builder connection control device may determine whether the first body builder information package and the second body builder information package are the same as each other, where the first body builder information package is included in the connection request message and the second body builder information package in included in the connection or disconnection check request message.

In S1050, the body builder connection control device may maintain the connection between the vehicle and the body builder, based on determining that the first body builder information package and the second body builder information package are the same as each other, and may perform body builder control based on the first body builder information package.

In S1060, the body builder connection control device may perform verification of the body builder based on body builder verification information included in the second body builder information package, based on determining that the first body builder information package and the second body builder information package are different from each other.

The body builder connection control device may determine a connection between the vehicle and the body builder, based on a result determined by performing the verification of the body builder based on the body builder verification information included in the second body builder information package. In detail, in S1070, the body builder connection control device may perform body builder control based on the second body builder information package, based on determining that the verification of the second body builder information package is completed. On the other hand, in S1080, the body builder connection control device may set a connect mode of the body builder connection control device to a first connect mode (i.e., a default mode), based on determining that the verification of the second body builder information package fails.

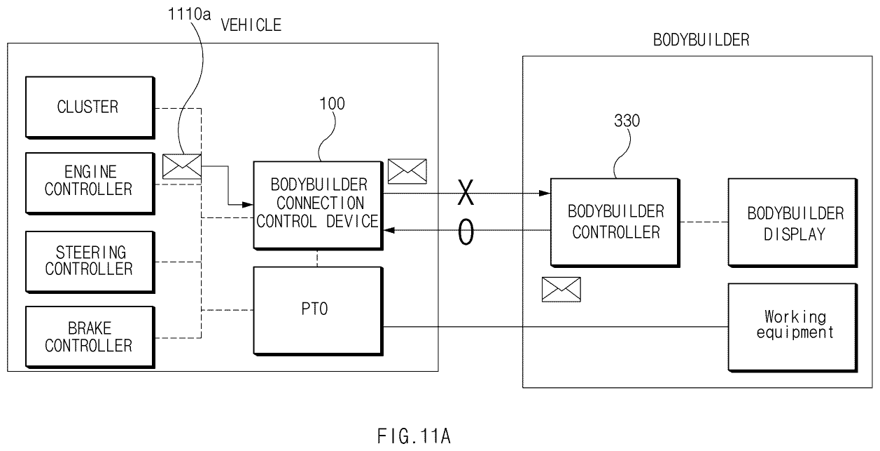

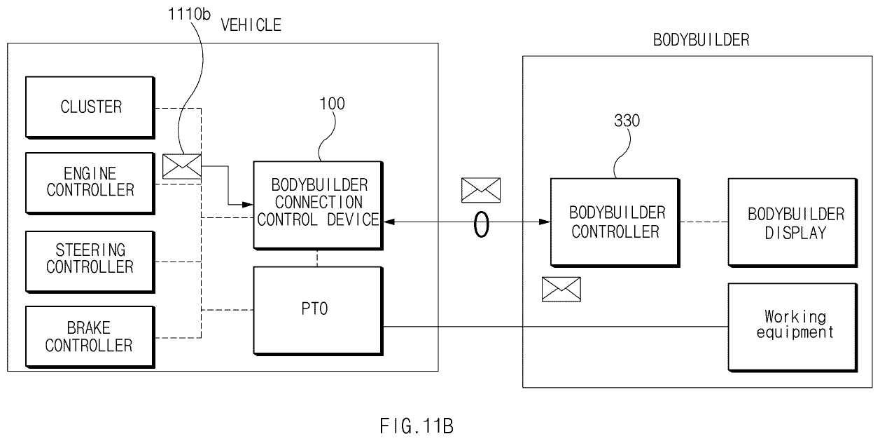

FIGS. 11A and 11B are drawings for describing an example of message transmission and reception according to a connect mode, in a body builder connection control device according to an embodiment of the present disclosure.

Referring to FIG. 11A, FIG. 11A illustrates whether it is possible to transmit a message 1110a generated by a vehicle to a body builder controller 330, if a connect mode of a body builder connection control device 100 is a first connect mode. For example, if the message 1110a is generated by an engine controller to be transmitted to the body builder connection control device 100, the body builder connection control device 100 may receive the message 1110a transmitted from the engine controller. However, if the connect mode is the first connect mode, the body builder connection control device 100 is unable to transmit the message 1110a to the body builder controller 330. If the connect mode is the first connect mode, the body builder connection control device 100 may receive only a CAN identifier in a connection request message transmitted from the body builder controller 330.

Referring to FIG. 11B, FIG. 11B illustrates whether it is possible to transmit a message 1110b generated by the vehicle to the body builder controller 330, if the connect mode of the body builder connection control device 100 is a connect mode (e.g., a second connect mode or a third connect mode) different from the first connect mode. For example, if the message 1110b is generated by the engine controller to be transmitted to the body builder connection control device 100, the body builder connection control device 100 may receive the message 1110b transmitted from the engine controller. If the connect mode is the connect mode different from the first connect mode, the body builder connection control device 100 may transmit the message 1110b to the body builder controller 330. If the connect mode is the connect mode different from the first connect mode, the body builder connection control device 100 may receive the message transmitted from the body builder controller 330.

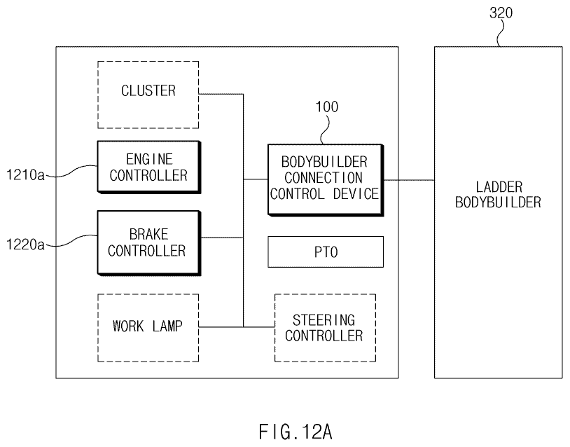

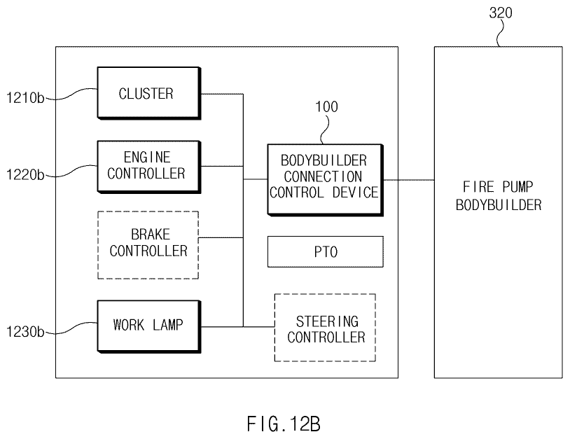

FIGS. 12A and 12B are drawings illustrating an example of a controller of a vehicle accessible according to a type of a connected body builder.

FIGS. 12A and 12B are drawings illustrating a configuration capable of accessing a controller of a vehicle according to a type of a body builder connected with the vehicle. FIGS. 12A and 12B illustrate a system for allowing a specific body builder to access various controllers and control a necessary function via a body builder connection control device 100.

Referring to FIG. 12A, FIG. 12A illustrates an example of accessing a controller of a vehicle, if a ladder body builder 320 is connected. The ladder body builder 320 may perform On/Off of the engine via an engine controller 1210a. As a result, the ladder body builder 320 may adjust a necessary engine state during work. The ladder body builder 320 may control On/Off of a parking brake via a brake controller. The parking brake may be used to maintain a safely fixed state upon ladder work. The ladder body builder 320 may ensure a stable work state via such controller access and may control the vehicle to safely perform work.

Referring to FIG. 12B, FIG. 12B illustrates an example of accessing a controller of a vehicle, if a fire pump body builder 320 is connected. It is important for the fire pump body builder 320 to control engine power, a power take-off (PTO) device, and a work lamp for fire control. The fire pump body builder 320 may control On/Off of the PTO device via a cluster 1210b. The fire pump body builder 320 may control On/Off of the engine and engine RPM via an engine controller 1220b. As a result, the fire pump body builder 320 may set engine power necessary to adjust pressure of the pump. The fire pump body builder 320 may control On/Off of the pump via a work lamp controller 1230b. It is essential to operate a work pump for water pumping upon fire control work. The fire pump body builder 320 may perform a stable pumping function via the above-mentioned controller and may receive necessary power for fire control work.

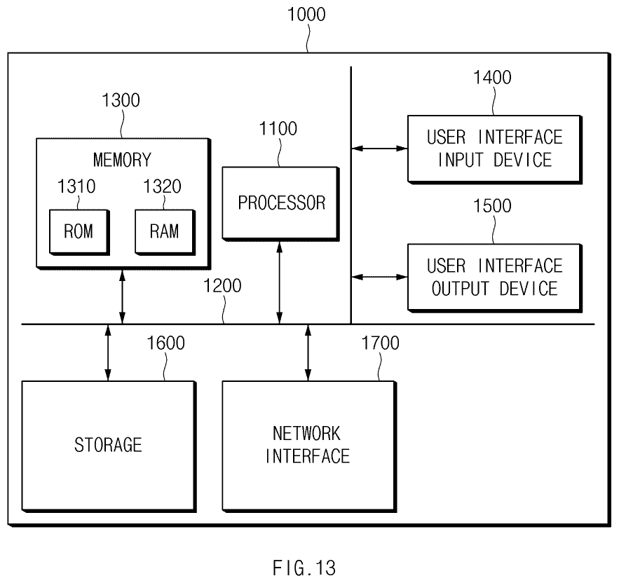

FIG. 13 is a drawing illustrating a computing system associated with a body builder connection control device or a body builder connection control method according to an embodiment of the present disclosure.

Referring to FIG. 13, a computing system 1000 used with the body builder connection control device or the body builder connection control method may include at least one processor 1100, a memory 1300, a user interface input device 1400, a user interface output device 1500, a storage 1600, and a network interface 1700, which are connected with each other via a bus 1200.

The processor 1100 may be a central processing unit (CPU) or a semiconductor device that processes instructions stored in the memory 1300 and/or the storage 1600. The memory 1300 and the storage 1600 may include various types of volatile or non-volatile storage media. For example, the memory 1300 may include a ROM (Read Only Memory) 1310 and a RAM (Random Access Memory) 1320.

Accordingly, the operations of the method or algorithm described in connection with embodiments of the present disclosure may be directly implemented with a hardware module, a software module, or a combination of the hardware module and the software module, which is executed by the processor 1100. The software module may reside on a storage medium (that is, the memory 1300 and/or the storage 1600) such as a RAM, a flash memory, a ROM, an EPROM, an EEPROM, a register, a hard disc, a removable disk, and a CD-ROM.

The storage medium may be coupled to the processor 1100. The processor 1100 may read out information from the storage medium and may write information in the storage medium. Alternatively, the storage medium may be integrated with the processor 1100. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to several embodiments and the accompanying drawings, the present disclosure is not limited thereto. Rather, the present disclosure may be variously modified and altered by those having ordinary skill in the art to which the present disclosure pertains without departing from the spirit and scope of the present disclosure claimed in the following claims.

The above-described embodiments may be implemented with hardware components, software components, and/or a combination of hardware components and software components. For example, the devices, methods, and components described in the embodiments may be implemented using general-use computers or special-purpose computers, such as a processor, a controller, an arithmetic logic unit (ALU), a digital signal processor, a microcomputer, a field programmable array (FPGA), a programmable logic unit (PLU), a microprocessor, or any device which may execute instructions and respond. A processing unit may perform an operating system (OS) or a software application running on the OS. Further, the processing unit may access, store, manipulate, process and generate data in response to execution of software. It should be understood by those having ordinary skill in the art that although a single processing unit may be illustrated for convenience of understanding, the processing unit may include a plurality of processing elements and/or a plurality of types of processing elements. For example, the processing unit may include a plurality of processors or one processor and one controller. Also, the processing unit may have a different processing configuration, such as a parallel processor.

Software may include computer programs, codes, instructions or one or more combinations thereof and may configure a processing unit to operate in a desired manner or may independently or collectively instruct the processing unit. Software and/or data may be permanently or temporarily embodied in any type of machine, component, physical equipment, virtual equipment, computer storage medium or unit or transmitted signal waves so as to be interpreted by the processing unit or to provide instructions or data to the processing unit. Software may be dispersed throughout computer systems connected over networks and be stored or executed in a dispersion manner. Software and data may be recorded in one computer-readable storage media.

The methods according to embodiments may be implemented in the form of program instructions that may be executed through various computer means and may be recorded in computer-readable media. The computer-readable media may include program instructions, data files, data structures, and the like alone or in combination, and the program instructions recorded on the media may be specially designed and configured for an example or may be known to and usable by those having ordinary skill in the art to which the present disclosure pertains. Examples of computer-readable media include magnetic media such as hard disks, floppy disks, and magnetic tape; optical media such as compact disc-read only memory (CD-ROM) disks and digital versatile discs (DVDs); magneto-optical media such as floptical disks; and hardware devices that are specially configured to store and perform program instructions, such as read-only memory (ROM), random access memory (RAM), flash memory, and the like. Examples of computer programs include not only machine language codes created by a compiler, but also high-level language codes that are capable of being executed by a computer by using an interpreter or the like.

The above-described hardware devices may be configured to act as one or a plurality of software modules to perform the operations of the embodiments, or vice versa.

Even though the embodiments are described with reference to restricted drawings, it should be apparent to one having ordinary skill in the art that the embodiments are variously changed or modified based on the above description. For example, adequate effects may be achieved even if the foregoing processes and methods are carried out in different order than described above, and/or the aforementioned components, such as systems, structures, devices, or circuits, are concatenated or coupled in different forms and modes than as described above or be substituted or switched with other components or equivalents.

A description is given below of the effects of the body builder connection control device and the method thereof according to an embodiment of the present disclosure.

According to at least one of embodiments of the present disclosure, the body builder connection control device may perform verification of a body builder based on body builder verification information included in a body builder information package included in a connection request message received from a body builder controller, based on identifying the body builder information package, and may determine a connection between a vehicle and the body builder, thus using the vehicle as a multi-purpose vehicle in the form of a smart dynamic vehicle (SDV), via connection with various body builders.

In addition, various effects ascertained directly or indirectly through the present disclosure may be provided.

Therefore, other implementations, other embodiments, and equivalents to claims are within the scope of the following claims.

Therefore, embodiments of the present disclosure are not intended to limit the technical spirit of the present disclosure, but provided only for the illustrative purpose. The scope of the present disclosure should be construed on the basis of the accompanying claims, and all the technical ideas within the scope equivalent to the claims should be included in the scope of the present disclosure.

What is claimed is:

1. A body builder connection control device, comprising:
a memory storing computer-executable instructions; and
a processor configured to execute the computer-executable instructions,
wherein the processor is configured to:
receive a connection request message from a body builder controller, wherein the connection request message includes a body builder information package including body builder verification information,
perform verification of a body builder based on the body builder verification information included in the body builder information package, and
determine a connection between a vehicle and the body builder based on performing the verification of the body builder.

2. The body builder connection control device of claim 1, wherein:
the connection request message further includes a connection request controller area network (CAN) identifier, and
the body builder information package further includes at least one of body builder request information or body builder authentication information, or any combination thereof.

3. The body builder connection control device of claim 2, wherein the processor is configured to:
determine a connect mode of the body builder connection control device;
identify requested connection information included in the body builder request information, based on determining that the connect mode of the body builder connection control device is a first connect mode capable of receiving a message requesting a connection from the body builder controller; and
transmit an error message to the body builder controller, based on determining that the connect mode of the body builder connection control device is a connect mode different from the first connect mode before a time point when the requested connection information is identified.

4. The body builder connection control device of claim 3, wherein the processor is configured to:
perform the verification of the body builder, based on determining that the requested connection information is a second connect mode capable of receiving a message indicating a state of the body builder from the body builder controller;
determine the second connect mode as the connect mode of the body builder connection control device, based on determining that the requested connection information is the second connect mode and the verification of the body builder is successful; and
transmit the error message to the body builder controller, based on determining that the requested connection information is the second connect mode and the verification of the body builder is not successful.

5. The body builder connection control device of claim 3, wherein the processor is configured to:
determine whether a manufacturer of the body builder is a manufacturer permitted to be capable of controlling the vehicle, based on determining that the requested connection information is a third connect mode capable of receiving a message for vehicle control from the body builder controller; and
determine that the verification of the body builder is successful, based on determining that the manufacturer of the body builder is the manufacturer predetermined to be capable of controlling the vehicle.

6. The body builder connection control device of claim 5, wherein the processor is configured to:
transmit the error message to the body builder controller, based on determining that the requested connection information is the third connect mode and the manufacturer of the body builder is not the manufacturer predetermined to be capable of controlling the vehicle;
determine whether the body builder is a body builder predetermined by a manufacturer of the vehicle, based on determining that the requested connection information is the third connect mode and the verification of the body builder is successful; and
determine the third connect mode as the connect mode of the body builder connection control device, based on determining that the body builder is the body builder predetermined by the manufacturer of the vehicle.

7. The body builder connection control device of claim 1, wherein the processor is configured to:
determine a type of the body builder based on an indication of the type included in the body builder verification information;
determine whether the type of the body builder is a body builder predetermined to be connectable with the vehicle to perform the verification of the body builder;
determine the connection between the vehicle and the body builder based on information included in the body builder information package, based on determining that the type of the body builder is the body builder predetermined to be connectable with the vehicle; and
transmit a message indicating routing allowance to the body builder controller, based on determining that the connection between the vehicle and the body builder is permitted.

8. The body builder connection control device of claim 1, wherein the processor is configured to:
drop the connection request message, based on determining that the connection request message is received before a time point when activation of an ignition of the vehicle is identified; and
transmit a connection or disconnection check request message to the body builder controller, based on identifying the activation of the ignition of the vehicle after a time point when the connection between the vehicle and the body builder is determined by the connection request message.

9. The body builder connection control device of claim 8, wherein the processor is configured to:
determine whether a first body builder information package and a second body builder information package are the same as each other, wherein the first body builder information package is included in the connection request message and the second body builder information package is included the connection or disconnection check request message;
maintain the connection between the vehicle and the body builder, based on determining that the first body builder information package and the second body builder information package are the same; and
perform the verification of the body builder based on body builder verification information included in the second body builder information package, based on determining that the first body builder information package and the second body builder information package are different.

10. The body builder connection control device of claim 9, wherein the processor is configured to:
determine the connection between the vehicle and the body builder, based on a result determined by performing the verification of the body builder based on the body builder verification information included in the second body builder information package.

11. A body builder connection control method, comprising:
receiving a connection request message from a body builder controller, wherein the connection request message includes a body builder information package including body builder verification information;
performing verification of a body builder based on the body builder verification information included in the body builder information package; and
determining a connection between a vehicle and the body builder based on performing the verification of the body builder.

12. The body builder connection control method of claim 11, wherein:
the connection request message further includes a connection request controller area network (CAN) identifier; and
the body builder information package further includes at least one of body builder request information or body builder authentication information.

13. The body builder connection control method of claim 12, wherein determining the connection between the vehicle and the body builder includes:
determining a connect mode of a body builder connection control device;
identifying requested connection information included in the body builder request information, based on determining that the connect mode of the body builder connection control device is a first connect mode capable of receiving a message requesting a connection from the body builder controller; and
transmitting an error message to the body builder controller, based on determining that the connect mode of the body builder connection control device is a connect mode different from the first connect mode before a time point when the requested connection information is identified.

14. The body builder connection control method of claim 13, wherein determining the connection between the vehicle and the body builder includes:
performing the verification of the body builder, based on determining that the requested connection information is a second connect mode capable of receiving a message indicating a state of the body builder from the body builder controller;
determining the second connect mode as the connect mode of the body builder connection control device, based on determining that the requested connection information is the second connect mode and the body builder is verified; and
transmitting the error message to the body builder controller, based on determining that the requested connection information is the second connect mode and the body builder is not verified.

15. The body builder connection control method of claim 13, wherein determining the connection between the vehicle and the body builder includes:
determining whether a manufacturer of the body builder is a manufacturer predetermined to be capable of controlling the vehicle, based on determining that the requested connection information is a third connect mode capable of receiving a message for vehicle control from the body builder controller; and
performing the verification of the body builder, based on determining that the manufacturer of the body builder is the manufacturer predetermined to be capable of controlling the vehicle.

16. The body builder connection control method of claim 15, wherein determining the connection between the vehicle and the body builder includes:
transmitting the error message to the body builder controller, based on determining that the requested connection information is the third connect mode and the manufacturer of the body builder is not the manufacturer predetermined to be capable of controlling the vehicle;
determining whether the body builder is a body builder predetermined by a manufacturer of the vehicle, based on determining that the requested connection information is the third connect mode and the body builder is verified; and
determining the third connect mode as the connect mode of the body builder connection control device, based on determining that the body builder is the body builder predetermined by the manufacturer of the vehicle.

17. The body builder connection control method of claim 11, wherein determining the connection between the vehicle and the body builder includes:
determining a type of the body builder, the type being included in the body builder verification information;
determining whether the type of the body builder is a body builder predetermined to be connectable with the vehicle to perform the verification of the body builder;
determining the connection between the vehicle and the body builder via information included in the body builder information package, based on determining that the type of the body builder is the body builder predetermined to be connectable with the vehicle; and
transmitting a message indicating routing allowance to the body builder controller, based on determining that the connection between the vehicle and the body builder is determined.

18. The body builder connection control method of claim 11, wherein determining the connection between the vehicle and the body builder includes:
dropping the connection request message, based on determining that the connection request message is received before a time point when activation of an ignition of the vehicle is identified; and
transmitting a connection or disconnection check request message to the body builder controller, based on identifying the activation of the ignition of the vehicle after a time point when the connection between the vehicle and the body builder is determined by the connection request message.

19. The body builder connection control method of claim 18, wherein determining the connection between the vehicle and the body builder includes:
determining whether there a first body builder information package and a second body builder information package are the same as each other, wherein the first body builder information package is included in the connection request message and the second body builder information package is included the connection or disconnection check request message;
maintaining the connection between the vehicle and the body builder, based on determining that the first body builder information package and the second body builder information package are the same as each other; and
performing the verification of the body builder based on body builder verification information included in the second body builder information package, based on determining that the first body builder information package and the second body builder information package are different from each other.

20. The body builder connection control method of claim 19, wherein the determining of the connection between the vehicle and the body builder includes:
determining the connection between the vehicle and the body builder, based on a result determined by performing the verification of the body builder based on the body builder verification information included in the second body builder information package.
